(19) United States
(12) Patent Application Publication
(10) Pub. No.: US 2013/0216923 A1
(43) Pub. Date: Aug. 22, 2013

(54) ELECTRO-CATALYST

(71) Applicants: Seyed Schwan Hosseiny, Molbergen (DE); Machiel Saakes, Schiedam (NL); Matthias Wessling, Enschede (NL)

(72) Inventors: Seyed Schwan Hosseiny, Molbergen (DE); Machiel Saakes, Schiedam (NL); Matthias Wessling, Enschede (NL)

(73) Assignee: MAGNETO Special Anodes B.V.

(21) Appl. No.: 13/812,464

(22) PCT Filed: Jun. 23, 2011
(86) PCT No.: PCT/NL2011/050455

§ 371 Date: May 6, 2013

Related U.S. Application Data
(60) Provisional application No. 61/368,381, filed on Jul. 28, 2010.

(30) Foreign Application Priority Data
Jul. 28, 2010 (EP) 10171068.9

(51) Int. Cl. H01M 4/92; H01M 12/06; H01M 8/10; H01M 4/90

(52) U.S. Cl. CPC H01M 4/921; H01M 4/9041; H01M 4/9075; H01M 4/925; H01M 12/06; H01M 8/10
USPC 429/405; 429/524; 429/526; 429/527; 429/532; 429/533; 429/485

(57) ABSTRACT

The present invention relates to an electro-catalyst M′ₐIrbM_{c}, wherein M′ is selected from the group consisting of Pt, Ta and Ru, and wherein the molar ratio a:b is within the range of 85:15 to 50:50 and the molar ratio a:c is within the range of 50:50 to 95:5, both calculated as pure metal and wherein M is selected from metals from Groups 3-15 of the Periodic System of Elements. The present invention further relates to an electrode comprising a support and the electro-catalyst. The present invention further relates to the use of the electro-catalyst and/or the electrode in electrochemical processes which comprise an oxygen reduction reaction (ORR), an oxygen evolution reaction (OER), a hydrogen evolution reaction (HER), a hydrogen oxidation reaction (HOR), a carbon monoxide oxidation reaction (COR) or a methanol oxidation reaction (MOR).

### SUMMARY OF THE INVENTION

The present invention relates to an electro-catalyst comprising a first metal selected from the group consisting of Pt, Ta and Ru, a second metal which is Ir and a third metal. The present invention also relates to the use an electrode comprising the electro-catalyst and the use of said electrode in electro-catalytic processes. In particular, the electro-catalyst can be used as a bifunctional air electrode which can be employed for the oxygen reduction reaction, the oxygen evolution reaction, the hydrogen evolution reaction, the hydrogen oxidation reaction, the carbon monoxide oxidation reaction and the methanol oxidation reaction.

### BACKGROUND OF THE INVENTION

The application of metal-based catalysts in electro-catalytic processes is well known in the art. For example, hydrogen/air fuel cells generate electric energy by converting a fuel, usually hydrogen. Such fuel cells conventionally comprise two half cells separated by a membrane (e.g. Nafion®), wherein the hydrogen is oxidized at the anode, usually a Pt-based anode, and the corresponding half-reaction (also called “Hydrogen Oxidation Reaction” or “HOR”) is:
H₂→2H⁺2e⁻(E°=0.0 V vs. NHE)

Instead of hydrogen, methanol, ethanol and formic acid can in principle be used as fuel, although anodic oxidation of these types of fuels is cumbersome. A direct methanol fuel cell (DMFC) is for example disclosed in K. Scott et al., J. Appl. Electrochem. 31, 823-832, 1991, incorporated by reference. Since fuel cells must operate under electro-neutral conditions, a reduction must occur at the cathode which usually involves the reduction of oxygen (O₂). Catalysts that are usually employed are also Pt-based. The corresponding half-reaction (also called “Oxygen Reduction Reaction” or “ORR”) is:
O₂+4H⁺+4e⁻→2H₂O (E°=1.23 V vs. NHE)

The oxidation of hydrogen proceeds readily, in contrast to the ORR. The ORR must occur in an acidic environment and is hampered by slow kinetics. These slow kinetics cause that substantial electrical current density cannot be generated at the thermodynamic potential difference ΔE=1.23 V and that a higher overpotential (the driving force) is required to produce a reasonable current density. Although this can be partly circumvented by using e.g. higher Pt-loadings on the cathode, this results in higher costs. Other problems involve the side-reaction to hydrogen peroxide which affects cathode stability and which can even result in decomposition of the membrane separating the half-cells. Reference is made to A. E. Gewirth and M. S. Thorum, Inorg. Chem. 49, 3557-3566, 2010, incorporated by reference. As a consequence, Pt-based cathodes that can produce higher electrical current densities without producing significant overpotentials are desired.

Stamenkovic et al., Angew. Chem. Int. Ed. Engl. 45, 2897-2901, 2006, incorporated by reference, present a model how 3d transition metals influence the activity of Pt-catalyst in the ORR. The catalyst studied were Pt₃M, wherein M is Ti, Fe, Co or Ni.

The DOE Annual Progress Report 2009, published in November 2009, incorporated by reference, Section V.E.2, discloses the electro-catalyst Pt₂IrCr, Pt₂IrFe, Pt₂IrCo, Pt₂IrNi, Pt₄IrCo₃, Pt₄Ir₅Co_{1.53} and Pt₆IrCo₇ and their application in the ORR.

Another well-known electrochemical reaction is the oxygen evolution reaction (“OER”) which for example occurs at the anode in several industrial processes such as production of hydrogen by alkaline reduction of water. The half-reaction is:
4OH⁻→O₂+2H₂O+4e⁻(E°=0.40 V vs. NHE)

Oxygen production is usually not a prime target, although it is useful where there is a demand for oxygen, e.g. in spacecrafts and submarines. The OER is usually performed with Ni-based catalysts in alkaline media. They require, however, higher overpotentials than e.g. Ru- and Ir-based catalysts. On the other hand, the Ru- and Ir-based catalysts suffer from the disadvantage that they are expensive and that they have a poor long term stability in alkaline media. See M. E. G Lyons and M. P. Brandon, Int. J. Electrochem. Sci. 3, 1386-1424, 2008, incorporated by reference. Hence, there is a need in the art for efficient metal-based catalyst for the OER, in particular in acidic media.

The hydrogen evolution reaction (HER) on Pt-cathodes is for example disclosed in J. O. M Bockris et al., J. Chem. Phys. 61, 879-886, 1957, incorporated by reference.

The use of PtPd on tungsten carbide nanocrystals is disclosed in M. Wu et al., J. Power Sources 166, 310-316, 2007, incorporated by reference. B. Pyrozynsky, Int. J. Electrochem. Sci. 6, 63-77, 2011, incorporated by reference, discloses that catalysts for HER based on Pt, Pt—Ru, Pt—Ir, as well as other metals and alloys thereof such as Ni, Co, Pb, Zn—Ni, Ni—P, Ni—Mo, Ni—Mo—Fe are known from the prior art.

Rechargeable Zn/air fuel cells are electro-chemical batteries wherein Zn is oxidized with oxygen. These batteries have high energy densities W.h/l (more in relation to small batteries) and high specific energies W.h/kg (more in relation to large batteries) and their manufacture is inexpensive. W.h/l means the volumetric energy density in watthours per liter while W.h/kg means the gravimetric energy density (or specific energy) in watthours per kg. They are used in e.g. watches, hearing devices, film cameras (all examples of small batteries) and electric vehicles (example of large battery). WO 2010/052336, incorporated by reference, discloses rechargeable Zn/air batteries. The relevant half-reactions are:
Zn+4OH⁻→Zn(OH)₄²⁻+2e⁻(E°=−1.285 V vs. NHE)
O₂+2H₂O+4e⁻4OH (E°=0.34 V vs. NHE)

U.S. Pat. No. 4.528.084, incorporated by reference, discloses catalysts for the OER comprising a platinum-group metal (Groups 8-10 of the Periodic System of the Elements) such as Ru, Rh, Ir and/or Pt. Example XI discloses a Pt/Ir catalyst.

U.S. Pat. No. 4,797,182, incorporated by reference, also discloses Pt/Ir catalysts having an excellent life time which can be used for the OER.

US 2007/0166602, incorporated by reference, discloses bifunctional air electrodes that catalyze both ORR and OER. These electrodes comprise a combination of an OER catalyst and a bifunctional catalyst. The OER catalyst includes Mn, Sn, Fe, Co, Pt or Pd. The bifunctional catalyst includes La₂O₃, Ag₂O or spinels (i.e. metal oxides of the formula AB₂O₄, wherein A is a divalent metal cation such as Mg, Fe, Ni or Zn and V is a trivalent metal cation such as Al, Fe, Cr or Mn).

WO 2006/046453, incorporated by reference, discloses electrode catalysts for fuel cells comprising Pt, Ir and a third metal M selected from the Group consisting of Ti, Zr, V, Cr, Mn, Fe, Co, Ni, Cu and Zn. Preferably, the third metal is Co. The ratios of Pt:Ir:M are preferably 1:0.02-2:0.02:2. Example 6 of WO 2006/046453 discloses Pt₄Ir₂Co.

The object of the present invention is to provide electro-catalysts that can catalyze both the oxygen reduction reaction as well as the oxygen evolution reaction. A further object is that these electro-catalysts have a prolonged lifetime and are stable in operation. Another object of the invention is to provide electro-catalysts that can catalyze the hydrogen evolution reaction, the hydrogen oxidation reaction, the carbon monoxide oxidation reaction and the methanol oxidation reaction.

### SUMMARY OF THE INVENTION

The present invention relates to a catalyst, preferably an electro-catalyst M′ₐIr_{b}M_{c}, wherein M′ is selected from the group consisting of Pt, Ta and Ru, and wherein the molar ratio a:b is within the range of 85:15 to 50:50 and the molar ratio a:c is within the range of 50:50 to 95:5, both calculated as pure metal. The present invention further relates to the use of these catalysts in electro-catalytic processes.

### DESCRIPTION OF THE FIGURES

FIG. 1 shows the results of a life-cycle test of the catalyst Pt—Ir (69:31; weight ratio).

FIG. 2 shows the results of a life-cycle test of the catalyst Pt—Ir—V (69:29:2; weight ratio).

FIG. 3 shows the results of a cyclic voltammetry study on the oxygen evolution reaction for the catalysts Pt—Ir (70:30) and Pt—Ir—V (63:27:10).

FIG. 4 shows the results of a cyclic voltammetry study on the oxygen reduction reaction for the catalysts Pt—Ir (70:30) and Pt—Ir—V (63:27:10).

FIG. 5 shows the results of a cyclic voltammetry study on the hydrogen evolution reaction for catalysts Pt—Ir (70:30) and Pt—Ir—V (63:27:10).

FIG. 6 shows the results of a cyclic voltammetry study on CO stripping for the catalyst Pt.

FIG. 7 shows the results of a cyclic voltammetry study on CO stripping for the catalyst Pt—Ir (70:30).

FIG. 8 shows the results of a cyclic voltammetry study on CO stripping for the catalyst Pt—Ir—V (63:27:10).

FIG. 9 shows the results of a cyclic voltammetry study on the oxygen evolution reaction for the catalysts Ta—Ir (81:19) and Ta—Ir—V (80:19:1).

FIG. 10 shows the results of a cyclic voltammetry study on oxygen evolution reaction for the catalysts Ru—Ir (70:30) and Ru—Ir—V (69:29:2).

FIG. 11 shows XRD-patterns of the catalyst Pt—Ir (70:30).

FIG. 12 shows XRD-patterns of the catalyst Pt—Ir—V (63:27:10).

### DETAILED DESCRIPTION OF THE INVENTION

The verb “to comprise” as is used in this description and in the claims and its conjugations is used in its non-limiting sense to mean that items following the word are included, but items not specifically mentioned are not excluded. In addition, reference to an element by the indefinite article “a” or “an” does not exclude the possibility that more than one of the elements is present, unless the context clearly requires that there is one and only one of the elements. The indefinite article “a” or “an” thus usually means “at least one”.

In this document, the anode is an electrode where a substrate is oxidised (i.e. that electrons are released) under the influence of an electric current. An anodic compartment is a compartment comprising an anode. Likewise, a cathode is an electrode where a substrate is reduced (i.e. that electrons are consumed) under the influence of an electric current. A cathodic compartment is a compartment comprising a cathode.

In this document, the catalysts, preferably the electro-catalyst, are defined in terms of the ratios of the metals as such. However, as will be apparent to the person skilled in the art, these catalysts are usually manufactured from their oxides and or salts, usually inorganic salts. Accordingly, the definition of the catalysts also comprises catalysts comprising metals in the form of oxides and/or salts, provided that the ratios of the metals are as defined in this document.

According to the present invention, it is preferred that the electro-catalyst PtₐIr_{b}M_{c} is not selected from the group consisting of Pt₄Ir₂Co, Pt₂IrCr, Pt₂IrFe, Pt₂IrCo, Pt₂IrNi, Pt₄IrCo₃, Pt₄Ir₅Co_{1.53} and Pt₆IrCo₇.

According to a preferred embodiment, M is selected from the group consisting of metals from Groups 3-15 of the Periodic System of the Elements (IUPAC Table 22 June 2007), provided that the metal from which M is selected is not Pt, Ta, Ru or Ir as will be apparent to those skilled in the art, more preferably Groups 3-11. More preferably, M is selected from the group consisting metals from Rows 4-6 of the Periodic System of the Elements (IUPAC Table 22 June 2007), more preferably Row 4. Even more preferably, M is selected from the group consisting of Sc, V, In, Cr, Mn, Co, Ni and Cu and most preferably from the group consisting of V, In, Ni and Co.

The present invention also relates to an electrode comprising a support and the electro-catalyst according to the present invention. The support is preferably metal-based. The metal is preferably titanium. The support is preferably in the form of sintered titanium, titanium mesh, titanium felt, titanium foam, titanium particles, or titanium foil.

The present invention further relates to an electro-catalytic process, wherein an electro-catalyst according to the present invention is used. The electro-catalytic process preferably comprises an oxygen reduction reaction (ORR), an oxygen evolution reaction (OER) or both an oxygen reduction reaction (ORR) and an oxygen evolution reaction (OER). The OER and/or ORR may occur as a side-reaction. Furthermore, the electro-catalytic process can be performed in alkaline media or in acidic media.

According to another embodiment, the electro-catalytic process comprises a hydrogen evolution reaction (HER), a hydrogen oxidation reaction (HOR), a carbon monoxide oxidation reaction (COR), or a methanol oxidation reaction (MOR).

According to the present invention, the electro-catalytic process is selected from the group consisting of electroplating, oxidative treatment of organic pollutants, electro-flotation, salt splitting, water splitting, electrochemical synthesis of organic species, electro-dialysis, metal recovery, metal refining, electrochemical synthesis of pure elements, oxygen reduction as cathodic process, in particular in a fuel cell, and oxidation of water to oxygen as anodic process in electrochemical applications, in particular in a fuel cell.

The present invention further relates to an electro-chemical cell comprising an electro-catalyst and/or an electrode according to the present invention. The electro-chemical cell is preferably a fuel cell (which includes both a non-rechargeable fuel cell and a rechargeable fuel cell), a battery, a redox flow battery, a direct methanol fuel cell or a metal/air, preferably a Zn/air, rechargeable cell.

The battery is preferably an all metal battery or a metal oxygen battery, more preferably a metal oxygen battery and more preferable a redox flow battery with a redox couple, preferably with a redox couple M^{z+}/M^{y+} with z and y being an integer and y larger than z.

The present invention also relates to chemical hydrogenation reactions and chemical oxidation reactions wherein the catalysts according to the present invention are employed. Preferred catalysts for these processes are those wherein M′ is Pt. More preferred catalysts for these processes are those wherein M′ is Pt and M is V.

### EXAMPLES

### Example 1

The catalysts were prepared by the general methods disclosed in U.S. Pat. No. 4.528.084 and U.S. Pat. No. 4,797,182. According to these general methods, a support for the catalyst is degreased and etched with a diluted acid. Subsequently, a paint comprising the required metal salts or oxides is applied. The support is dried and heated in air at about 500° C. If desired several layers of paint can be applied which are subsequently dried and heated.

A PtIr (70:30) catalyst was prepared as follows. A titanium sheet (160×30×1 mm) was degreased and etched (20% HCl, 90° C.) and then rinsed with deionised water. An aqueous solution of H₂PtCl₆ and IrCl₃ was applied by coating. The coating thickness was 5 g/m². The titanium sheet was then dried and heated at about 500° C.

A TaIr catalyst was prepared as follows. A titanium sheet (160×30×1 mm) was degreased and etched (20% HCl, 90° C.) and then rinsed with deionised water. An organic solution of butanol with of Ta(V) ethoxide and H₂IrCl₆ was applied by coating. The coating thickness was 5 g/m². The titanium sheet was then dried and heated at about 500° C.

A PtIrV (70:30:10) catalyst was made in the same manner. The coating thickness was 10 g/m².

### Example 2

Cyclic voltammetry measurements were performed on catalyst compositions under the following conditions:

Electrolyte: H₂SO₄ (25% w/w)

Potential: −300/1600 mV

Scanning speed: 5 mV/s

Temperature: 25° C. (in oven)

Reference electrode: Ag/AgCl

Air flow through electrolyte: yes

The catalyst compositions (on Ti support) and the results are shown in Table 1.

TABLE 1

| | Catalyst | | | Catalyst | | | ORR | OER |
|---|---|---|---|---|---|---|---|---|
| | wt % | | | mol % | | | Iₘₐₓ | Iₘₐₓ (A/m²) at +1600 mV |
| M | Pt | Ir | M | Pt | Ir | M | (A/m²) | vs. Ag/AgCl |
| — | 70 | 30 | 0 | 70 | 30 | 0 | −0.9 | 29 |
| V | 76 | 21 | 3 | 70 | 20 | 10 | −1.6 | 52 |
| V | 63 | 27 | 10 | 49 | 21 | 30 | −4.4 | 127 |
| In | 56 | 24 | 20 | 49 | 21 | 30 | −4.4 | 66 |
| Ni | 76 | 21 | 3 | 70 | 20 | 10 | −0.9 | 11 |
| Co | 76 | 21 | 3 | 70 | 20 | 10 | −0.9 | 19 |

### Example 3

In a life-cycle test, a Pt—Ir catalyst (70:30 weight ratio) and a Pt—Ir—V catalyst (69:29:2 weight ratio), both on a Ti support, were compared at a current density of 2500 A/m² alternatively as anode and cathode (polarity switch every five minutes). Test was conducted at 50° C. in 1 mol/l Na₂SO₄.

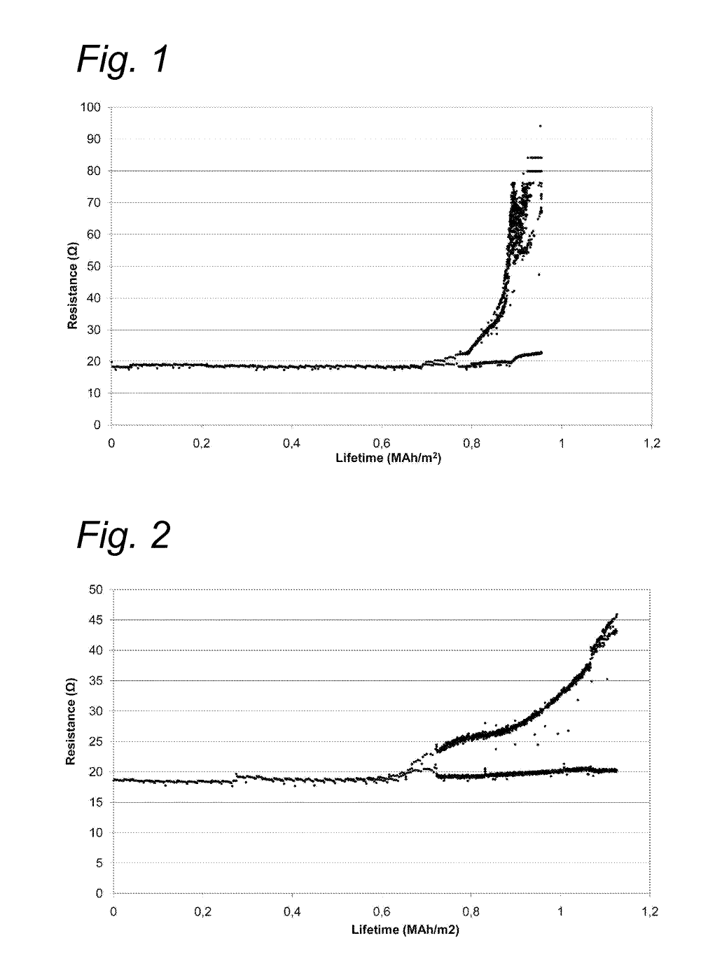

The Pt—Ir—V catalyst had a higher activity in the HER, HOR, ORR and OER than the Pt—Ir catalyst (life-cycle time for Pt—Ir—V was 1.06 MAh/m²=102.3 kAh/g.m²); life-cycle time for Pt—Ir was 0.86 MAh/m²=80.7 kAh/g.m²). The results are shown in FIGS. 1 and 2. Hence, the life-cycle for Pt—Ir—V is increased with about 27% relative to Pt—Ir (102.3/80.7=1.27).

### Example 4

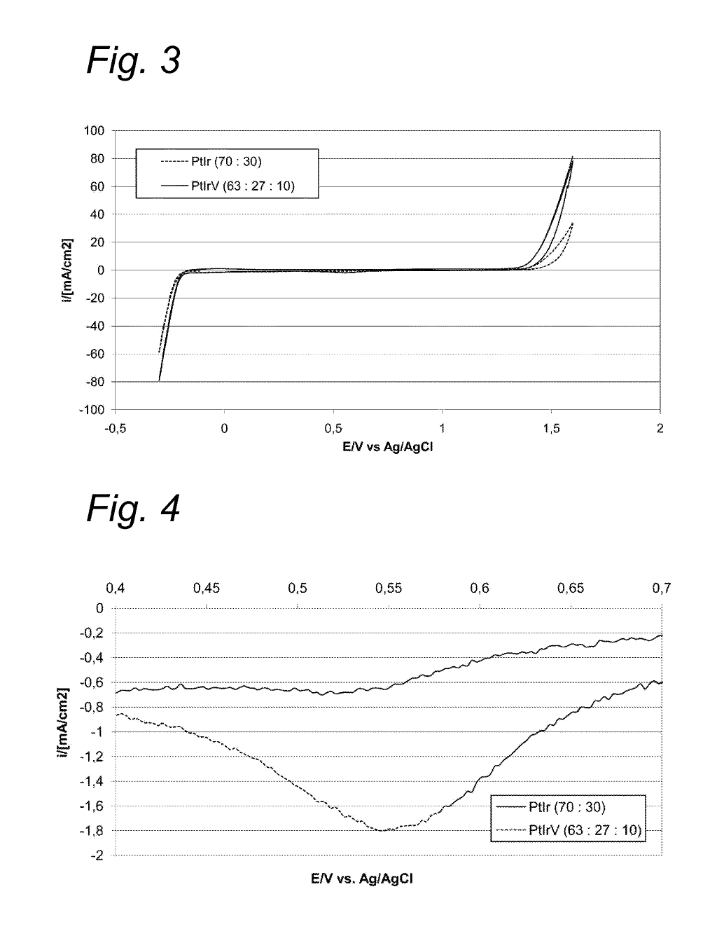

The catalysts according to Example 3 were also evaluated by cyclic voltammetry measurements at ambient temperature (25 wt. % H₂SO₄). The scan rate was 5 mV/s. FIG. 3 shows the oxygen evolution reaction for Pt—Ir (70:30 weight ratio) and Pt—Ir—V (63:27:10 weight ratio).

### Example 5

The catalysts Pt, Pt—Ir (70:30 weight ratio) and Pt—Ir—V (63:27:10 weight ratio), all on a Ti support, were tested for their activity in the ORR. Test conditions were as in Example 4. Results are shown in FIG. 4 which shows the backward scan (0.6 V-0.4 V). The Pt—Ir—V catalyst is about four to five times more active than the Pt—Ir and Pt catalysts.

### Example 6

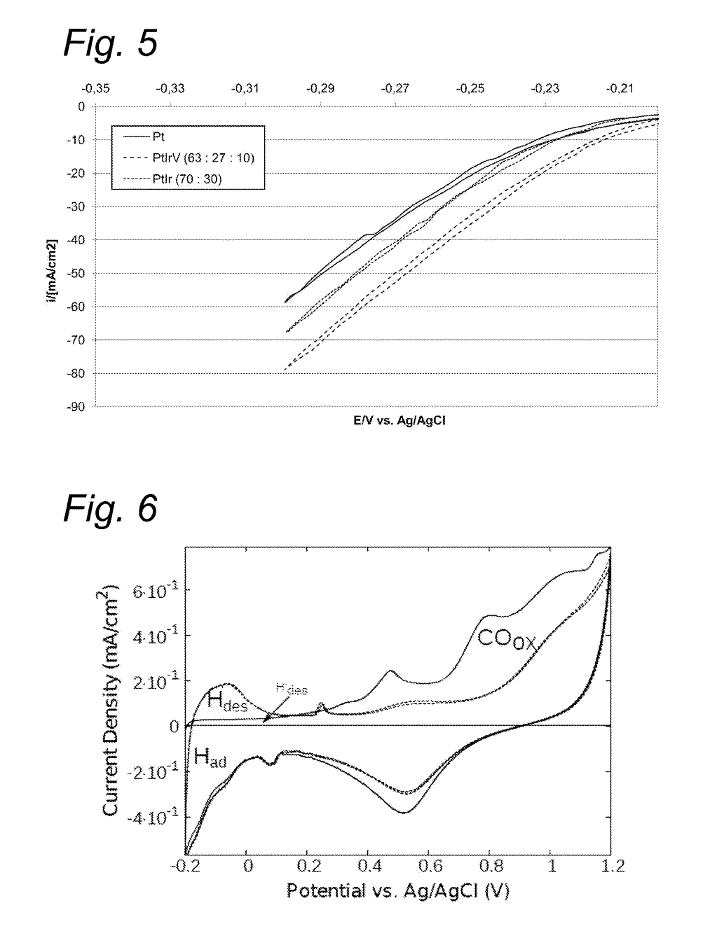

The catalysts according to Example 5 were tested in the HER. Test conditions were as in Example 4. The results are shown in FIG. 5. It appears that the Pt—Ir—V catalyst was the most active.

### Example 7

The catalysts according to Example 4 were evaluated by CO stripping voltammetry. The cyclic voltammetry measurements were preformed at ambient temperature (0.5 M % H₂SO₄). The scan rate was 20 mV/s. The results are shown in

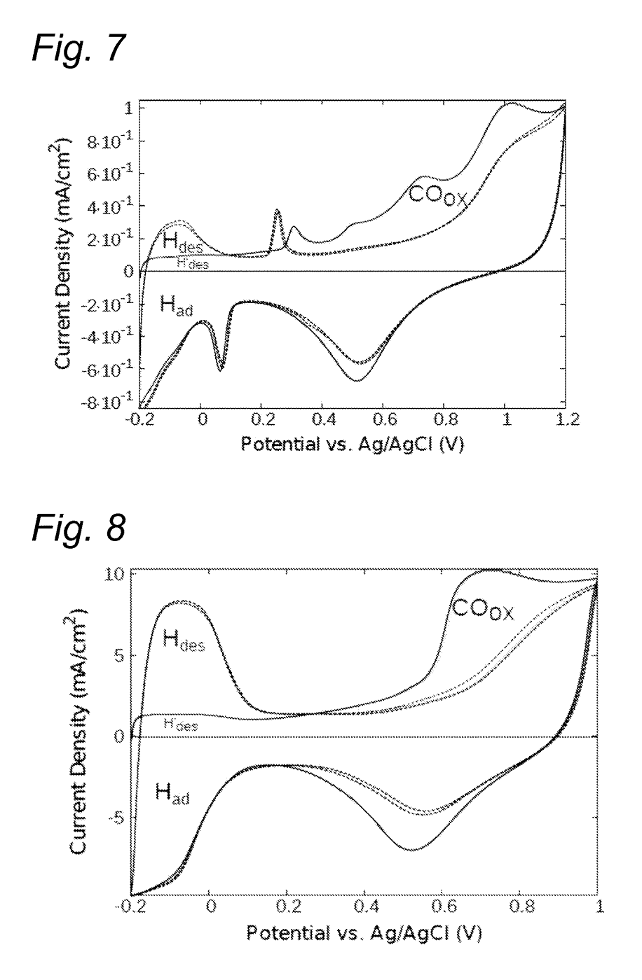

FIGS. 6, 7 and 8. The solid line indicates the first scan, the dashed line indicates the the second and the third scan. The symbols have the following meaning: COₒₓ=CO oxidation, H_{ad}=hydrogen adsorption, H_{des}=hydrogen desorption after CO oxidation, H′_{des}=hydrogen desorption before CO oxidation. These results indicate that the Pt—Ir—V may be a good catalyst for DMFC since the carbon monoxide oxidation proceeds more readily on this catalyst.

### Example 8

The following catalyst were prepared according to the method disclosed in Example 1: Ta—Ir (81:19 weight ratio), Ta—Ir—V (≈81:19:0.4 weight ratio), Ta—Ir—V (≈80:19:0.8 weight ratio) and Ta—Ir—V (80:19:1 weight ratio). Test conditions were as in Example 4.

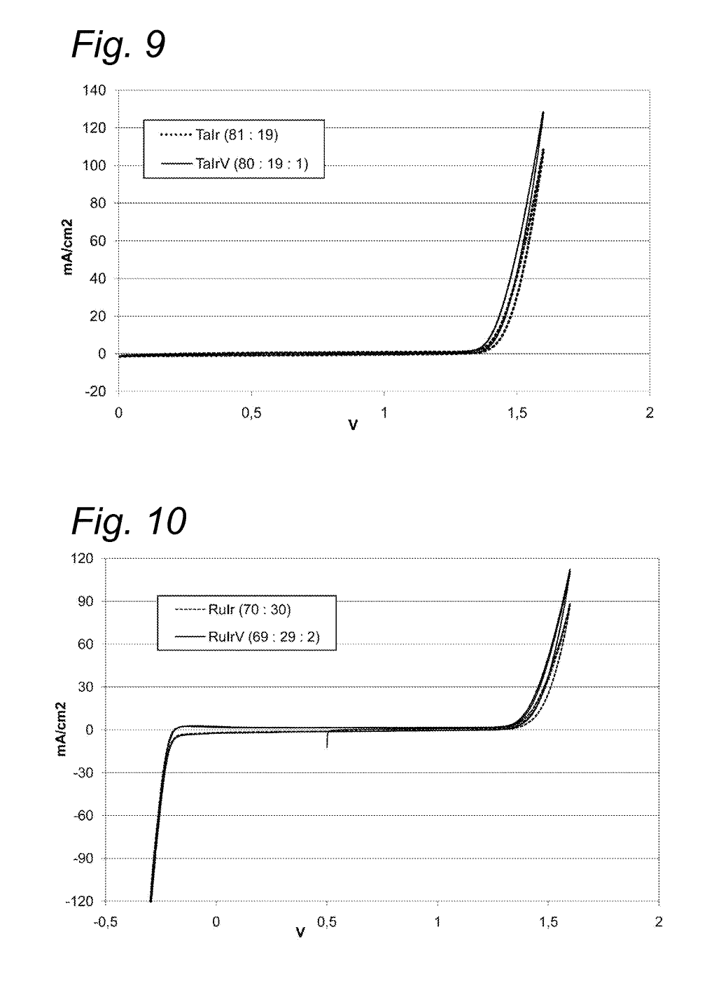

FIG. 9 shows the results for the OER evaluation for Ta—Ir (81:19) and Ta—Ir—V (80:19:1).

### Example 9

The following catalyst were prepared according to the method disclosed in Example 1: Ru—Ir (70:30) and Ru—Ir—V (69:29:2). Test conditions were as in Example 4.

FIG. 10 shows the results for the OER evaluation for Ru—Ir (70:30) and Ru—Ir—V (69:29:2).

### Example 10

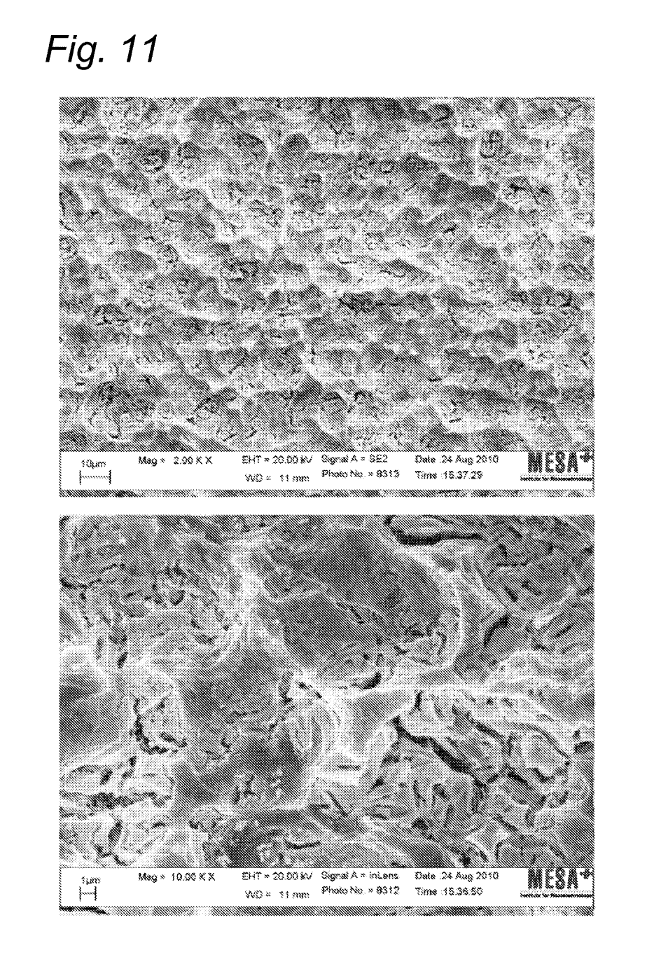

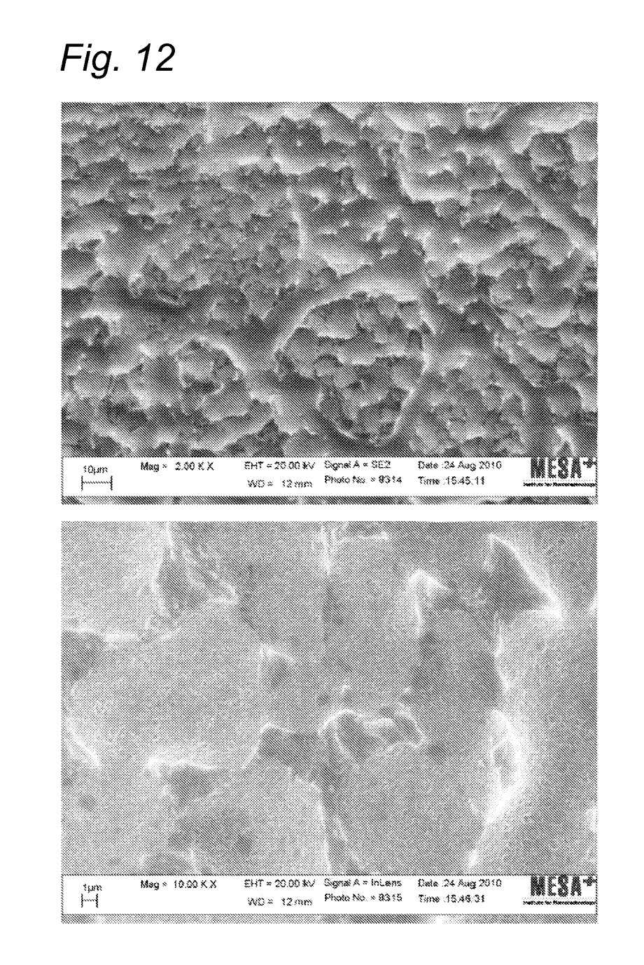

FIGS. 11 and 12 show XRD-patterns at two different magnifications of Pt—Ir (70:30) and Pt—Ir—V (63:27:10), respectively. Whereas FIG. 11 show a grain like morphology with crack defects, FIG. 12 does not show cracks and grain like domains appear to be bridged by an intergrain phase.

1-19. (canceled)

20. An electrode comprising a titanium-based support and an electro-catalyst M′ₐIr_{b}M_{c}, wherein M′ is selected from the group consisting of Pt, Ta and Ru, and wherein the molar ratio a:b is within the range of 85:15 to 50:50 and the molar ratio a:c is within the range of 50:50 to 95:5, both calculated as pure metal, and wherein M is selected from the group consisting metals from Groups 3-15 of the Periodic System of the Elements (IUPAC Table 22 June 2007).

21. The electrode according to claim 20, wherein the electro-catalyst PtₐIr_{b}M_{c} is not selected from the group consisting of Pt₄Ir₂Co, Pt₂IrCr, Pt₂IrFe, Pt₂IrCo, Pt₂IrNi, Pt₄IrCo₃, Pt₄Ir₅Co_{1.53} and Pt₆IrCo₇.

22. The electrode according to claim 20, wherein M is selected from the group consisting metals from Rows 4 to 6 of the Periodic System of the Elements (IUPAC Table 22 June 2007).

23. The electrode according to claim 21, wherein M is selected from the group consisting metals from Rows 4 to 6 of the Periodic System of the Elements (IUPAC Table 22 June 2007).

24. The electrode according to claim 21, wherein M is selected from the group consisting metals from Row 4 of the Periodic System of the Elements (IUPAC Table 22 June 2007).

25. The electrode according to claim 22, wherein M is selected from the group consisting metals from Row 4 of the Periodic System of the Elements (IUPAC Table 22 June 2007).

26. The electrode according to claim 20, wherein M is selected from the group consisting of Sc, V, In, Cr, Mn, Co, Ni and Cu.

27. The electrode according to claim 26, wherein M is selected from the group consisting of V, In, Ni and Co.

28. The electrode according to claim 20, wherein the support is in the form of sintered titanium, titanium mesh, titanium felt, titanium foam, titanium particles, or titanium foil.

29. An electro-chemical cell comprising an electrode according to claim 20.

30. The electro-chemical cell according to claim 29, wherein the cell is a fuel cell, a battery, a redox flow battery, a direct methanol fuel cell or a metal/air rechargeable cell.
